(19) United States
(12) Patent Application Publication
(10) Pub. No.: US 2008/0140434 A1
(43) Pub. Date: Jun. 12, 2008

(54) METHODS AND APPARATUS FOR ENHANCING EN ROUTE SERVICE TO PASSENGERS IN TRANSPORTATION SYSTEMS

(76) Inventor: Webster J. O'Brien, arlington, MA (US)

Correspondence Address: GARDERE WYNNE SEWELL LLP;INTELLECTUAL PROPERTY SECTION, 3000 THANKSGIVING TOWER, 1601 ELM ST, DALLAS, TX, 75201-4761, US

(21) Appl. No.: 11/872,697

(22) Filed: Oct. 15, 2007

Related U.S. Application Data
(60) Provisional application No. 60/829,489, filed on Oct. 13, 2006.

(51) Int. Cl. G06F 17/30

(52) U.S. Cl. 705/1

(57) ABSTRACT

A mobile device carried by service personnel is automatically loaded from one or more external databases with detailed information about specific customers relevant to the intended location such as, for example, passengers aboard a specific airplane flight, participants on a specific cruise, or convention attendees congregated in a specific meeting room. This information supports various forms of customer service delivery, such as, by way of example, one or more of the following: specific seating preferences, meal preferences, arrangements with traveling companions/associates, preferred form of address, and other information that facilitates or enhances the service provided by service-delivery personnel, such as flight attendants, cruise staff, or field sales representatives. When in range for wireless communications, or when physically connected to a wire-line connection, a mobile device for use in the field exchanges data with the system's one or more central databases, enabling staff in the field with the mobile device both to benefit from the use of database records while in the field and to provide updates on field activity and transactions to be relayed to and captured in a centralized system, and then relayed as necessary to one or more databases of applications.

### CROSS-REFERENCE TO RELATED APPLICATIONS

This application claims the benefit of U.S. Provisional Application Ser. No. 60/829,489, filed Oct. 13, 2006 and is incorporated herein by reference.

### BACKGROUND

In the contemporary travel industry, a variety of specific systems have been developed to help with various aspects of customer service delivery, customer relationship management, loyalty programs, onboard revenue enhancement, onboard service recovery, marketing of third-party products and services, retail transaction enablement, and automation of communications with onboard staff. However, each of these systems has a unique application, and no single conduit exists to enable all these and other like, potential activities. Additionally, many of these current systems are unable to address the lack of an electronic connection aboard a moving vessel (a ship, aircraft, or tour bus, for example) and so have served purely as in-office or online systems.

### SUMMARY

The invention pertains generally to methods and apparatus for enhancing delivery of service to customers by sales or customer service personnel operating in the field at a particular location, or by customers themselves while en route. Various aspects of the invention, in its preferred form, are described with reference to several exemplary applications and embodiments described below.

In one exemplary implementation of a mobile service enhancement system, a mobile device carried by service personnel is automatically loaded from one or more external databases with detailed information about specific customers relevant to the intended location such as, for example, passengers aboard a specific airplane flight, participants on a specific cruise, or convention attendees congregated in a specific meeting room. This information supports various forms of customer service delivery, such as, by way of example, one or more of the following: specific seating preferences, meal preferences, arrangements with traveling companions/associates, preferred form of address, and other information that facilitates or enhances the service provided by service-delivery personnel, such as flight attendants, cruise staff, or field sales representatives. When in range for wireless communications, or when physically connected to a wire-line connection, a mobile device for use in the field exchanges data with the system's one or more central databases, enabling staff in the field with the mobile device both to benefit from the use of database records while in the field and to provide updates on field activity and transactions to be relayed to and captured in a centralized system, and then relayed as necessary to one or more databases of applications. In a preferred embodiment, this exemplary system and method takes advantage of external database access, centralized database capability for use in synchronizing subsets of data hosted by external databases, and one or more remote devices to deliver a pre-selected subset of the information of these systems to sales or customer service staff operating in the field, such as aboard moving vessels, which are relevant to providing services.

One exemplary application of such a system is in connection with improving in-flight service aboard airlines by making available certain passenger-specific information to flight attendants and other service personnel in the cabin. This information includes one or more of the following types of information: drink order preferences, meal selections, current itinerary information, past travel information, upgrade and downgrade history, onboard purchase history, and non-airline travel preferences. The service information may be used, for example, for one or more of the following: (a) to manage service-recovery issues immediately, onboard, using full itinerary travel information, passenger revenue-value information, and complete past travel history; (b) to provide a controlled, onboard sales opportunity for airline products (such as food and beverage purchased in flight or onboard duty-free sales), travel partner products, and select express-delivery merchandise; and/or (c) to focus loyalty and marketing enhancements on only those customers flying in premium classes, eliminating waste of category-wide applications.

### BRIEF DESCRIPTION OF THE DRAWINGS

FIG. 1 schematically illustrates a system for enhancing delivery of service to customers by sales or customer service personnel operating in the field at a particular location, comprised of a core system with one or more databases and optional hosted applications, a remote or mobile device used in the field, and one or more systems for facilitating exchange of information between the core system and its remote devices.

FIG. 2 schematically illustrates the mobile device of FIG. 2, its components, and the paths for data exchange with the core system and other devices.

FIG. 3 schematically illustrates an approach for segmenting data in multiple databases, bringing it to a core system, and delivering the recombined data to devices intended for location-specific use in the field, such as aboard an airline flight.

FIG. 4 schematically illustrates multiple access and data-exchange paths for a host system with other storage or interface points.

FIG. 5 schematically illustrates an example of a method for accessing and preparing data records for a location-specific use.

### DETAILED DESCRIPTION OF EXEMPLARY EMBODIMENTS

In the following description, like numbers refer to like elements.

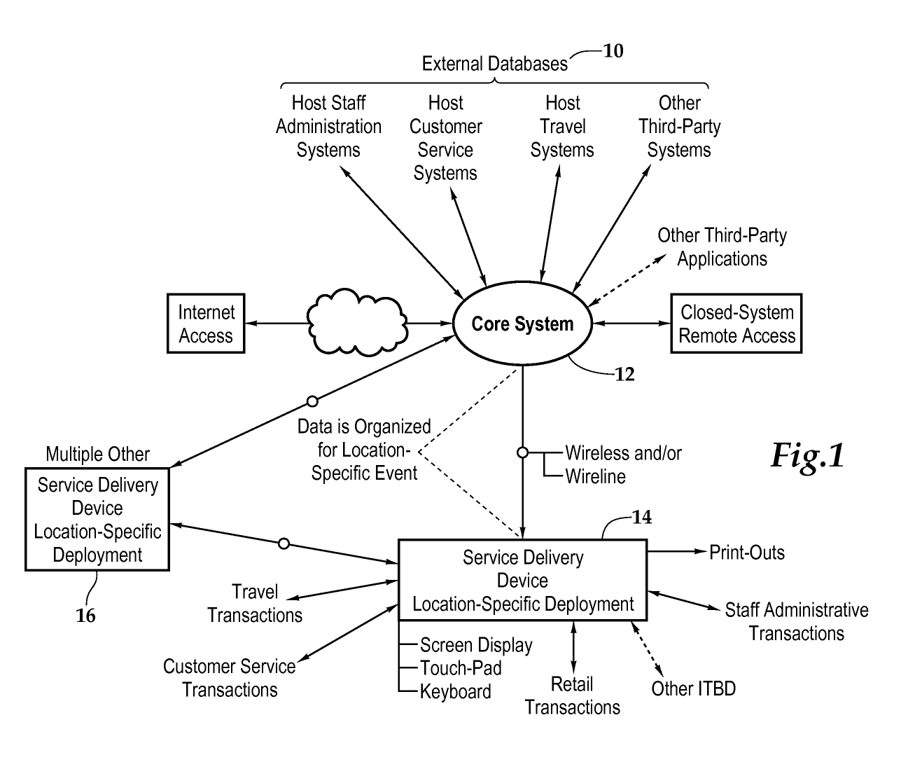

As demonstrated in FIG. 1, using the example of an airline flight application, information on passengers of an airline (or multiple airlines having sharing arrangements) is stored and maintained in one or more external databases 10. Using basic parameters about each flight's operation, core system 12 then accesses records from one or more of the external databases 10 and compiles/updates passenger information from those records in the core system. The core system is comprised of, for example, one or more software programs executing one or more computers. The computers can be used to host other systems. The records are preferably those that are relevant to in-flight servicing of the passengers. When the flight is ready to depart, the core system transfers the flight-specific data to a remote or mobile service delivery device 14 either wirelessly or via wire-line. This data is used in the field for various applications and displays, which may include one or more of travel transactions, customer service transactions, retail transactions, staff administrative transactions, or other location-specific transactions. The service delivery device 14 may optionally be capable of exchanging information directly or indirectly (such as through an on-board computing systems or networks or via a third-party wireless or wired communications system) with other service delivery devices 16 while in the field, including, for example, other devices on the same flight. Data from any transactions in the field is held in the service delivery device until it is ready to relay that data back to the core system, which then updates the external or other databases.

In its preferred embodiment, the core system 12 is comprised of one or more computers programmed to obtain a sub-set of records from external databases 10, each of which has potentially tens of millions of records. These databases are external in the sense that they are maintained by separate applications. These applications will typically be pre-existing, legacy systems. The core system may also cache records maintained by external databases and synchronize or update the records. For example, the sub-set records might include scheduled flights for a particular time period and passenger manifests for the flights. The sub-set of records may be updated on a predetermined basis. Based on these records, additional related records or certain information from those records, such flight-specific and passenger-specific information, are obtained from the same or different external databases. From this information the core system then automatically compiles, formats, and makes available the information to a service delivery device 14 for a specific location based on the parameters of that location (e.g. the passenger or staff list of a specific flight, or, in the case of a meeting, the participant list for a specific meeting). This location-specific capability governs what information was made available to customers, staff, or participants at that specific location. Once a service delivery device in the system was linked to a specific location, it would then receive the data sub-set unique to that location. Formatting algorithms in the system would govern how specific information was displayed in the device, suitable for the location, user, and application. For example, information might be grouped and displayed based on seats. Flight service personnel would access information for a particular seat—seat 3A for example. Based on the core system's knowledge that Mrs. Smith is assigned seat 3A, the information accessed for the flight attendant based on the seat number would be for Mrs. Smith.

One exemplary implementation of the data delivery system is comprised of a set of computers, databases, and interface access points, at least one of which is comprised of one or more pre-programmed mobile service delivery devices 14. These devices would connect to the system, at a minimum, once prior to the start and preferably also once at the end of the location-specific event. These connections would occur electronically, whether via physical cable connection, infrared transfer, Bluetooth wireless link, IEEE 802.11-governed wireless connection (“Wi-Fi”), telecommunications-hosted wireless data exchange, such as GRPS, EDGE, or other cellular network, or other methods of secure data communication. The delivery devices would preferably also have interfaces for connection with each other for relevant applications, such as the management of location-specific inventory (e.g., meals or duty-free stores aboard an aircraft).

In a transportation application, the service delivery device may, optionally, carry various forms of travel information. In this example, the device is preferably downloaded with data from other travel information systems maintained by the carrier or other entity so as to carry detailed information about the current and past travel of the customers in the specific location. Information about activity in travel programs (e.g. loyalty programs, reward programs) could, for example, also be carried in the service delivery device about the location-specific customers. Additional travel information about a specific travel-provider's schedule, availability, prices, and offerings, as up-to-date as appropriate, would preferably also be contained in the system. The service delivery device preferably would offer the ability to request or make travel arrangements based on this information and would have the ability to interface, when a connection is available, with the travel systems so as to execute the travel requests and disseminate such information to designees.

The mobile service delivery device may also optionally offer the capability to host retail transactions, whether using pre-loaded credit or debit card information provided for specific customers in the specific location, or via a card reader or similar device included in or linked to the device and operating in the specific location. The device, optionally, has the capability of carrying information about specific merchandise or services that could be purchased in the specific location using the system, whether those items for purchase were physically available in the specific location or are made available at another location or at a later date, and whether those items were purchased using money or purchased using credits earned in a pre-existing program linked to the core system. The device is preferably configured for carrying inventory information about the retail goods and services and would relay location-specific purchase information to those inventory systems.

The mobile service delivery device may, optionally, also be configured to store and provide administrative information to support the sales/customer service staff using the system. This information could take the form of manuals, service bulletins, or schedule information, for example, all of which would be carried electronically in the device and displayed in the specific location. The device preferably would offer interactive capability to access, respond to, or manipulate this information by location-specific staff, such as, for example, the ability participate in the work scheduling process by using the service delivery device in the specific location.

The device optionally tracks and assembles usage data. This data would be accessed and manipulated to assess rates, trends, and other information gathered from delivery-device data relays to the system.

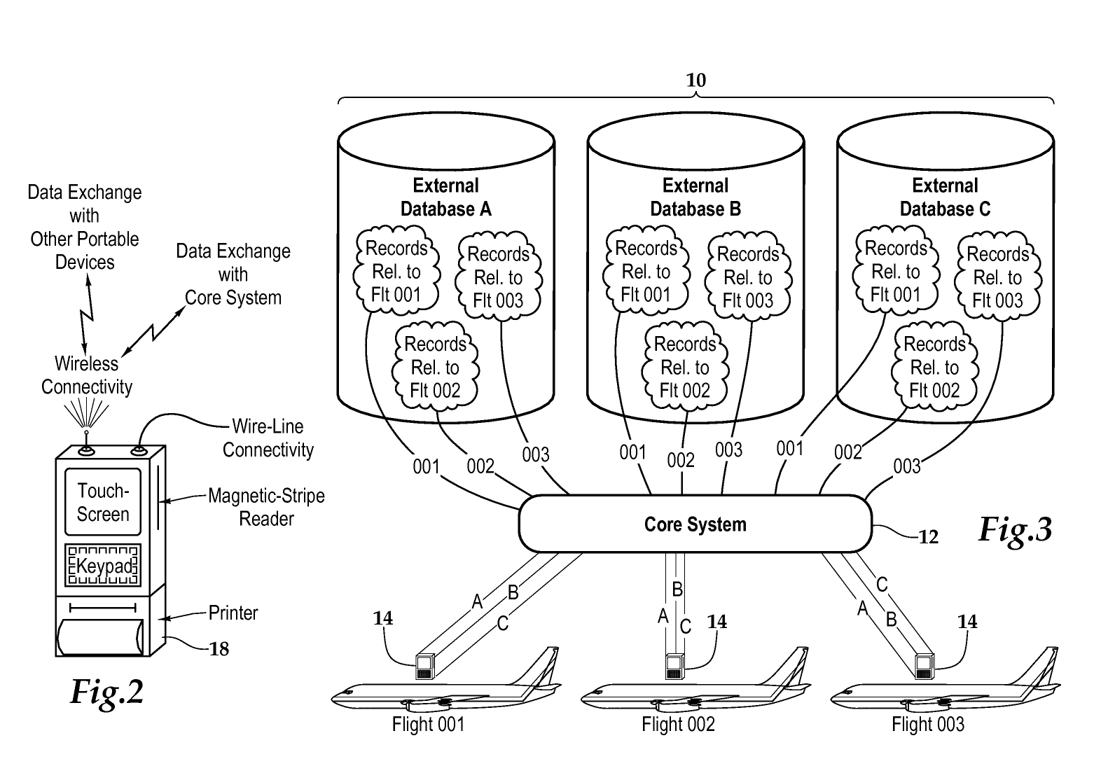

FIG. 2 demonstrates one example of service delivery device 14. Portable, batter-powered computing device 18 is comprised of memory (not shown) for storing detailed information on customers and a processor for executing software programs for enabling on board service personnel to interact with it to retrieve passenger service information, or to enable individual customers, accessing the device in a secure manner, to perform similar functions themselves. The device would carry and display this information electronically or, for example, touch screen 20. It may, optionally, include an interface for transferring information to hard media using, for example, a connected printer 22. The hard media would offer the additional advantage of supporting enhanced service delivery while in the specific location (e.g. flight, meeting room). The device may, optionally, include an input device in the form of a keypad 24 and a magnetic card reader 26. The device preferably also includes a wireless interface 28 (optical or RF) and a wired interface 30 for communicating with the core system 10 (not illustrated; see FIG. 1). The device is, optimally, programmed for automatically connecting with the core system over any interface when the connection becomes available. The service delivery device, in one embodiment, automatically connects to a network that it senses is available and over which it has been programmed to communicate. For example, it may connect over a USB, Ethernet, local wireless, or cellular data network when at a terminal (e.g. airport), and to an on-board network (wired or wireless) if available, which would in turn connect to an RF based network, which can be cellular, wide area (e.g. IEEE 802.16) or air-to-ground network base station. The device preferably is further capable of connecting with other service delivery devices over an ad hoc or local area network. Location-specific customer data would be downloaded to the device when in range of a wireless connection or when attached to a wire-line connection. In the same manner, location-based transaction data would be uploaded to the core system when those transactions were complete, or at later point.

FIG. 3 schematically illustrates how the core system 12 integrates independent applications or databases 10, 10a, 10b and 10c hosted on other systems and preferably also provides a single, stand-alone interface using service delivery devices 14 that sales/customer service staff use to retrieve and/or input relevant information for applications hosted on the core system 12. An example of one of these hosted capabilities is cashless point-of-sale, such that the system supports the use of standard electronic credit or debit accounts and a magnetic-stripe reader, whether with or without a memory chip reader. The core system manages access to these various components and combines records and data based on the location-specific needs of the sales/customer service staff. Examples of such locations include aircraft, cruise ships, or tour buses carrying customers, or in areas of hotels, casinos, or convention/meeting centers. In this example, the core system is retrieving from each of the databases records relating to three different airline flights 32, 34 and 36 and then synchronizing or downloading them to service delivery devices 14 that will be available on the flights.

The service delivery devices 14 thus enable the use of data in other database systems, drawn from those systems into the core system 12 via a dedicated link for such purpose, and could augment that information with additional data. Each service delivery device would allow its authorized users to review the pre-existing information and, optionally, edit or add to that information using an electronic device, either while in the specific location (e.g. using an electronic device aboard a flight) or remotely (e.g. from an Internet-access point). The edited or additional information would be synchronized to the relevant database by the core system.

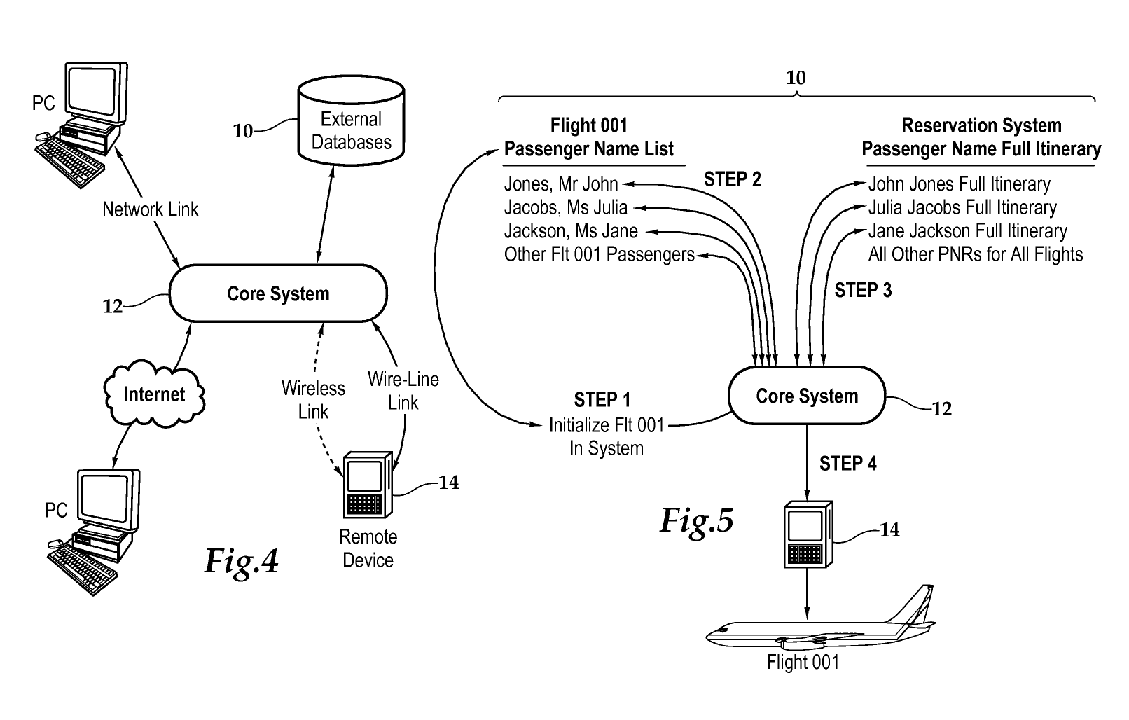

FIG. 4 illustrates how the core system 12 would be accessed via electronic devices in the field. This access could be from a device connected to the Internet or connected to a network that was linked to the core system. Access could also be from a customized device that had no function other than to provide an interface with the system. Such access would include screen displays and would accept keypad or touch-screen input. The devices would display selected system information and relay captured information to the system. The core system would manage the data exchange between these remote device access points and the external databases. The core system would likewise govern the prioritization of data messages flowing across the network of devices and external databases, be they directly linked or third-party databases, so as to rush immediate order information to fulfillment points, such as a new message to change an en-route customer's continuing itinerary or to ready a hired car service on arrival at a selected airport.

FIG. 5 schematically demonstrates how the device would carry detailed information about specific customers relevant to the intended location, such as passengers aboard a specific airplane flight, participants on a specific cruise, or convention attendees congregated in a specific meeting room. This information would directly support customer service delivery, such as common seating preferences, meal preferences, arrangements with traveling companions/associates, preferred form of address, and other information that facilitates or enhances the service provided by service-delivery personnel, such as flight attendants, cruise staff, or field sales representatives. A first step includes setting up or initiating the location—in this example, an airline flight. Based on a list of persons to be present at the location—in this example, a passenger list—predetermined data is retrieved from one or more external databases 10. The external database in this example is a reservation system containing full itineraries for all passengers of the airline. Only the itineraries of those passengers on the flight are downloaded to device 14, which is placed aboard or located on the plane.

The system may optionally be implemented as an open platform, with published or open APIs and data formats, for facilitating communication and exchange of data between the system and third party applications or other third party systems.

The foregoing description is of exemplary and preferred embodiments of a multiple dispense head pumps employing at least in part certain teachings of the invention. The invention, as defined by the appended claims, is not limited to the described embodiments. Alterations and modifications to the disclosed embodiments may be made without departing from the invention. The meaning of the terms used in this specification are, unless expressly stated otherwise, intended to have ordinary and customary meaning and are not intended to be limited to the details of the illustrated structures or the disclosed embodiments. None of the description in the present application should be read as implying that any particular element, step, or function is an essential element which must be included in the claim scope. The scope of patented subject matter is defined only by the allowed claims. Moreover, none of these claims are intended to invoke paragraph six of 35 USC §112 unless the exact words “means for” or “steps for” are followed by a participle.

What is claimed is:

1. A method for enhancing delivery of services at a remote location, comprising:
retrieving from each of one or more databases storing information specific to customers a subset of the information for customers expected to be at the remote location at a given time, the information including information relevant to servicing the customers at the remote location;
storing each subset of information on a mobile service delivery device; and
making the service delivery device available to service personnel at the remote location.
